(19) United States
(12) Patent Application Publication
(10) Pub. No.: US 2019/0376478 A1
(43) Pub. Date: Dec. 12, 2019

(54) Fuel Injection Valve and Method for Manufacturing Fuel Injection Valve

(71) Applicant: Hitachi Automotive Systems, Ltd., Hitachinaka-shi, Ibaraki (JP)

(72) Inventors: Akihiro YAMAZAKI, Hitachinaka-shi, Ibaraki (JP); Takahiro SAITO, Hitachinaka-shi, Ibaraki (JP); Nobuaki KOBAYASHI, Hitachinaka-shi, Ibaraki, (JP)

(21) Appl. No.: 16/476,792

(22) PCT Filed: Aug. 9, 2017
(86) PCT No.: PCT/JP2017/028879

§ 371 Date: Jul. 9, 2019

(30) Foreign Application Priority Data
Jan. 11, 2017 (JP) 2017-002399

(51) Int. Cl. F02M 51/06; F02M 61/16

(52) U.S. Cl. CPC F02M 51/0682; B23K 26/21; F02M 61/168

(57) ABSTRACT

This fuel injection valve is provided with a needle having a valve body (27c) and a rod part (27b) of which one end is bonded by welding to the valve body (27c). A contact portion (81) between the rod part (27b) and the valve body (27c) is disposed nearer to a valve shaft center (27x) than is a weld-penetration portion (80) created by the weld-bonding of the rod part (27b) and the valve body (27c), and a non-welded portion (82) is provided between the contact portion (81) and the weld-penetration portion (80).

### TECHNICAL FIELD

The present invention relates to a fuel injection valve for injecting fuel, and a method for manufacturing a fuel injection valve.

### Background Art

Japanese Patent Application Publication No. 2001-087882 (patent document 1) discloses a known fuel injection valve as a background art in this technical field. Patent document 1 discloses an art in which welding of two members different in hardness by a laser beam or electron beam is implemented by offsetting a point of irradiation of the laser beam or electron beam from joint surfaces of a high-hardness member and a low-hardness member toward the high-hardness member by a predetermined distance such that weld penetration caused by the beam is made to spread from the low-hardness member to the high-hardness member, in order to avoid poor welding which would otherwise cause cracks in the high-hardness member (see an abstract of patent document 1).

Patent document 1 discloses a fuel injection valve in which the art of welding described above is applied to welding of a valve rod and a valve element at their spherical joint surfaces (see paragraph [0029]), and discloses in FIG. 2 a configuration that a weld penetration portion is formed at an outer periphery of the joint surfaces.

### PRIOR ART DOCUMENT(S)

### Patent Document(s)

Patent Document 1: Japanese Patent Application Publication No. 2001-087882

### Summary of Invention

In the fuel injection valve according to patent document 1, the joint surfaces of the valve element and the valve rod are spherical, so that the valve element and the valve rod are in surface contact with each other through their large spherical areas. In this structure, due to limitation of the accuracy of machining of the joint surfaces of the valve element and the valve rod, it is impossible to completely bring the entire joint surfaces of the valve element and the valve rod into contact with each other. When the joint surfaces of the valve element and the valve rod are partially in contact with each other and a weld penetration portion is formed at a contact portion, it may fail to ensure a positional relationship between the valve element and the valve rod, allowing the overall length of the valve rod to change, or adversely affecting the coaxiality between the valve element and the valve rod. In the following, a portion corresponding to the valve rod according to patent document 1 is referred to as rod part.

It is an object of the present invention to provide a fuel injection valve in which a valve element and a rod part are welded to each other and the valve element and the rod part are maintained in a suitable positional relationship.

In order to accomplish the object described above, according to the present invention, a fuel injection valve comprises a movable element, wherein: the movable element includes: a movable core; a valve element; and a rod part connected between the movable core and the valve element and including a first end welded to the valve element; the rod part and the valve element include an abutment portion at which the rod part abuts the valve element; the rod part and the valve element include a weld penetration portion produced by welding of the rod part and the valve element; the abutment portion is closer to a valve central axis than the weld penetration portion; and the rod part and the valve element include an unwelded portion between the abutment portion and the weld penetration portion.

Moreover, according to the present invention, a production process is provided for a fuel injection valve including a movable element, wherein: the movable element includes: a movable core; a valve element; and a rod part connected between the movable core and the valve element and including a first end welded to the valve element; and the production process comprises welding the valve element to the first end of the rod part by: causing a rod part side facing surface to abut a valve element side facing surface at a radially intermediate place, wherein the rod part side facing surface is a surface of the rod part facing the valve element, and the valve element side facing surface is a surface of the valve element facing the rod part; and producing a weld penetration portion radially outside of an abutment portion at which the rod part side facing surface abuts the valve element side facing surface, for welding of the rod part and the valve element, while providing an unwelded portion between the abutment portion and the weld penetration portion.

According to the present invention, it is possible to weld the valve element and the rod part to each other, while maintaining the valve element and the rod part in a suitable positional relationship.

### BRIEF DESCRIPTION OF DRAWINGS

FIG. 1 is a sectional view of a fuel injection valve according to an embodiment of the present invention taken along a plane containing a valve central axis of the fuel injection valve.

FIG. 2 is an enlarged sectional view showing a movable element 27 and its proximity shown in FIG. 1.

FIG. 3 is an enlarged sectional view showing a nozzle part 8 and its proximity shown in FIG. 2.

FIG. 4 is a sectional view showing a modified example of the movable element in the fuel injection valve according to the embodiment of the present invention.

FIG. 5 is a conceptual diagram illustrating a problem about welding between a valve element and a rod part.

FIG. 6 is a conceptual diagram illustrating a change in positional relationship (positional deviation) between the valve element and the rod part caused by welding therebetween.

FIG. 7 is a schematic diagram showing an internal structure of a portion of welding between the valve element and the rod part by broken lines.

FIG. 8 is a sectional view of the portion of welding between the valve element and the rod part according to a first embodiment, taken along a plane containing the valve central axis.

FIG. 9A is a sectional view of the portion of welding between the valve element and the rod part according to a second embodiment, taken along a plane containing the valve central axis.

FIG. 9B is a sectional view (on the upper side) and a plan view (on the lower side) showing the portion of welding between the valve element and the rod part according to the second embodiment.

FIG. 10A is a sectional view of the portion of welding between the valve element and the rod part according to a third embodiment, taken along a plane containing the valve central axis.

FIG. 10B is a sectional view (on the upper side) and a plan view (on the lower side) showing the portion of welding between the valve element and the rod part according to the third embodiment.

FIG. 11 is a sectional view of an internal combustion engine to which the fuel injection valve is mounted.

### DESCRIPTION OF EMBODIMENTS

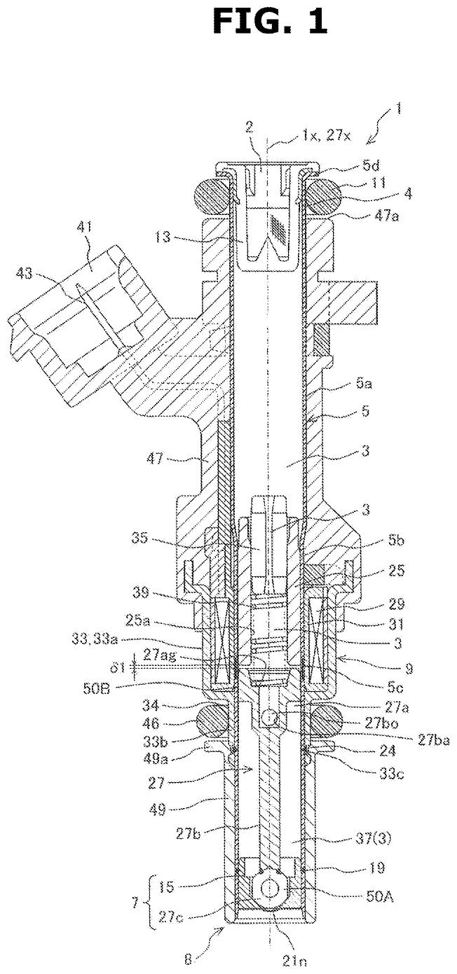

The following describes a fuel injection valve according to embodiments of the present invention with reference to FIGS. 1 to 3.

The following describes a general configuration or structure of a fuel injection valve 1 with reference to FIG. 1. FIG. 1 is a sectional view of a fuel injection valve according to an embodiment of the present invention taken along a plane containing a valve central axis of the fuel injection valve.

In FIG. 1, an upper end portion (upper end side) of the fuel injection valve 1 is also called a base end portion (base end side), and a lower end portion (lower end side) of the fuel injection valve 1 is also called a tip end portion (tip end side). These base end portion (base end side) and tip end portion (tip end side) are named based on a fuel flow direction of the fuel injection valve 1 or a connecting structure of the fuel injection valve 1 to a fuel pipe. Furthermore, in the present description, upper and lower positions of each element or component are based on FIG. 1, and these upper and lower positions have nothing to do with a vertical direction in a structure where the fuel injection valve 1 is mounted in an internal combustion engine. The fuel injection valve 1 has a central axis 1x that coincides with a central axis (valve central axis) 27x of a movable element 27 and also coincides with a central axis of a cylindrical body 5 and a central axis of a valve seat member 15.

In the fuel injection valve 1, a fuel flow passage (fuel passage) 3 is formed by a metal-made cylindrical body (cylindrical member) 5 inside the cylindrical body 5 so as to extend substantially along the central axis 1x. The cylindrical body 5 is made of a metal material such as magnetic stainless steel, and is formed into a step-bore shape in a direction along the central axis 1x by press forming such as deep-drawing.

Accordingly, one side (larger diameter part 5a) of the cylindrical body 5 has a larger diameter than the other side (smaller diameter part 5b) of the cylindrical body 5.

The cylindrical body 5 includes a base end portion provided with a fuel supply port 2. A fuel filter 13 is attached to the fuel supply port 2 for filtering out foreign particles entering included in the fuel.

The base end portion of the cylindrical body 5 is provided with a collar portion (diameter-widened portion) 5d formed by being bent and widened outwardly in the radial direction. An O-ring 11 is fitted in an annular recess (annular groove) 4 formed by the collar portion 5d and a base side end portion 47a of a resin cover 47.

At a tip end portion of the cylindrical body 5, a valve part 7 is composed of the valve element 27c and a valve seat member 15. The valve seat member 15 is inserted inside of the tip end side of the cylindrical body 5, and is fixed to the cylindrical body 5 by laser welding. The laser welding is performed from the outside of the cylindrical body 5 for an entire circumference of the cylindrical body 5. The valve seat member 15 may be press-fitted inside of the tip end side of the cylindrical body 5, and is fixed to the cylindrical body 5 by laser welding.

A nozzle plate 21n is fixed to the valve seat member 15 such that a nozzle part 8 is composed of the valve seat member 15 and the nozzle plate 21n. The valve seat member 15 is inserted and fixed inside the inner peripheral surface of the cylindrical member 5, so that the valve seat member 15 and the nozzle plate 21n are assembled to the tip end side of the cylindrical member 5.

The cylindrical member 5 according to this embodiment is constituted by one member extending from the portion where the fuel supply opening 2 is provided, to the portion to which the valve seat member 15 and the nozzle plate 21n are fixed. However, the portion (base end side portion) where the fuel supply opening 2 is provided, and the portion (tip end side portion) to which the valve seat member 15 and the nozzle plate 21n are provided may be constituted by separate members. The tip end side portion of the cylindrical member 5 constitutes a nozzle holder arranged to hold the nozzle part 8. In this embodiment, the nozzle holder and the base end side portion of the cylindrical member 5 are formed by the one member.

A actuation part 9 is disposed at an intermediate portion of the cylindrical member 5 for driving the valve element 27c. The drive portion 9 is constituted by an electromagnetic actuator (electromagnetic drive part). Specifically, the drive portion 9 includes: a stationary core 25 fixed in the inside (on the inner peripheral side) of the cylindrical member 5; the movable element 27 disposed within the cylindrical member 5 and on the tip end side of the stationary core 25, and arranged to move in a direction along the central axis 1a; an electromagnetic coil 29 mounted on an outer peripheral side of the cylindrical member 5 at a position at which the stationary core 25 faces a movable core 27a constituted in the movable element 27 through a minute gap δ1; and a yoke 33 structured to cover the electromagnetic coil 29 on the outer peripheral side of the electromagnetic coil 29.

The movable element 27 is received within the cylindrical member 5. The cylindrical member 5 faces the outer peripheral surface of the movable core 27a to constitute a housing surrounding the movable core 27a.

The movable core 27a, the stationary core 25, and the yoke 33 constitute a closed magnetic path in which a magnetic flux generated by energizing the electromagnetic coil 29 flows. Although the magnetic flux passes across the minute gap δ1, a nonmagnetic portion or a weaker magnetic portion having magnetism weaker than that of other portions of the cylindrical member 5 is provided at a position corresponding to the minute gap δ1 of the cylindrical member 5 so as to reduce a magnetic flux leakage flowing in the portion of the cylindrical member 5 corresponding to the minute gap δ1. Hereinafter, this nonmagnetic portion or weak magnetic portion is referred to merely as nonmagnetic portion 5c. This nonmagnetic portion 5c may be formed by nonmagnetizing (demagnetizing) the cylindrical member 5 having the magnetism. This nonmagnetization may be performed by heat treatment. Alternatively, this nonmagnetic portion 5c may be constituted by an annular recess formed in the outer peripheral surface of the cylindrical member 5, so as to reduce thickness of the portion corresponding to the nonmagnetic portion 5c.

The electromagnetic coil 29 is wound around a bobbin 31 made of a resin material in a cylindrical shape, and is mounted on the outer peripheral side of the cylindrical member 5. The electromagnetic coil 29 is electrically connected to a terminal 43 provided to a connector 41. The connector 41 is connected to an external drive circuit not shown to apply a drive current to the electromagnetic coil 29 through the terminal 43.

The stationary core 25 is made of a magnetic metal material. The stationary core 25 is formed into a cylindrical shape. The stationary core 25 includes a through hole 25a which extends through a central portion of the stationary core 25 in a direction along the central axis 1x. The through hole 25a constitutes a fuel passage (upstream side fuel passage) 3 on the upstream side of the movable core 27a. The stationary core 25 is fixed on the base end portion of the smaller diameter part 5b of the cylindrical member 5 by the press-fit. The stationary core 25 is positioned at an intermediate portion of the cylindrical member 5. The structure that the larger diameter part 5a is provided on the base end side of the smaller diameter part 5b, serves to allow the stationary core 25 to be assembled easily. The stationary core 25 may be fixed to the cylindrical member 5 by welding, or combination of welding and press-fit.

The movable element 27 is composed of the movable core 27a, the valve element 27c, and a rod part 27b. In the present embodiment, the rod part 27b and the movable core 27a are formed integrally, and the valve element 27c is welded to a tip end portion of the rod part 27b extending downwardly from the movable core 27a. The rod part 27b and the movable core 27a may be prepared separately, and then assembled together.

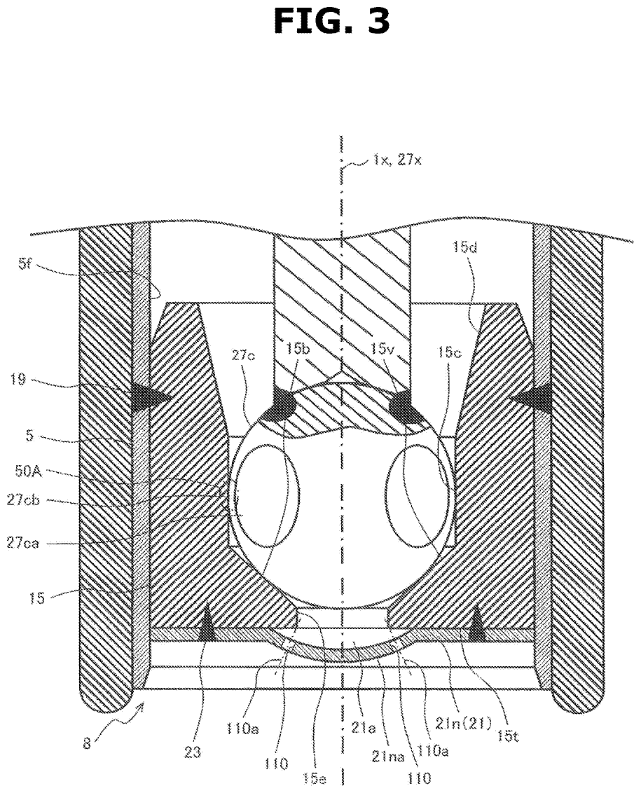

The movable core 27a is an annular member. The valve element 27c is a member that contacts or is seated on a valve seat 15b (see FIG. 3). The valve seat 15b and the valve element 27c open and close a fuel passage in cooperation with each other. The rod part 27b has a narrow cylindrical shape. The rod part 27b serves as a connecting part that connects the movable core 27a and the valve element 27c. The movable core 27a is connected to the valve element 27c, and drives the valve element 27c in opening and closing directions by a magnetic attraction force exerted between the stationary core 25 and the movable core 27a.

In the present embodiment, the rod part 27b and the movable core 27a are fixed to each other. However, the rod part 27b and the movable core 27a may be connected to each other in a manner to allow displacement therebetween.

In the present embodiment, the rod part 27b and the valve element 27c are prepared separately, and the valve element 27c is fixed to the rod part 27b. The fixation between the rod part 27b and the valve element 27c is implemented by welding.

The rod part 27b has a solid cylindrical shape. The rod part 27b has a recess 27ba that is formed in an upper end of the rod part 27b and extends in an axial direction of the rod part 27b. Between an outer peripheral surface of the rod part 27b and an inner peripheral surface of the cylindrical body 5, a fuel chamber 37 is formed. Here, the term “solid” is opposite to “hollow” and indicates “its inside is filled with substance”.

A coil spring 39 is provided in the through hole 25a of the stationary core 25. One end of the coil spring 39 abuts a spring seat 27ag that is provided inside of the movable core 27a. The other end of the coil spring 39 abuts an end surface of an adjuster 35 that is set in the through hole 25a of the stationary core 25. The coil spring 39 is installed in a compressed state between the spring seat 27ag and a lower end (tip end side end surface) of the adjuster 35.

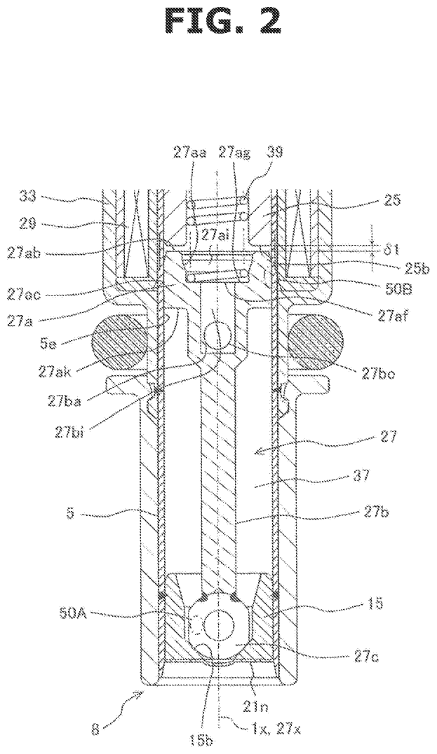

The coil spring 39 functions as a biasing member that biases the movable element 27 in a direction (valve closing direction) to cause the valve element 27c to contact or be seated on the valve seat 15b (see FIG. 2). By adjusting a position of the adjuster 35 in the direction along the central axis 1x in the through hole 25a, a biasing force acting on the movable element 27 (i.e. the valve element 27c) by the coil spring 39 is adjusted.

The adjuster 35 is provided with the fuel flow passage 3 that extends through the central portion of the adjuster 35 in the direction along the central axis 1x.

Fuel supplied from the fuel supply port 2 flows in the fuel flow passage 3 of the adjuster 35, and thereafter flows in the fuel flow passage 3 of the through hole 25a of the stationary core 25, and then flows into the recess 27ba of the movable element 27.

The yoke 33 is made of a magnetic metal material. The yoke 33 serves as a housing of the fuel injection valve 1. The yoke 33 is formed into a step-bore shape having a larger diameter part 33a and a smaller diameter part 33b. The larger diameter part 33a has such a cylindrical shape as to cover an outer periphery of the electromagnetic coil 29. At a tip end side of the larger diameter part 33a, the smaller diameter part 33b whose diameter is smaller than that of the larger diameter part 33a is formed. The smaller diameter part 5b of the cylindrical body 5 is press-fitted or inserted inside of the smaller diameter part 33b. Accordingly, the inner peripheral surface of the smaller diameter part 33b is in intimate contact with the outer peripheral surface of the cylindrical body 5. At least a part of the inner peripheral surface of the smaller diameter part 33b faces the outer peripheral surface of the movable core 27a through the cylindrical body 5. This reduces a magnetic resistance (magnetic reluctance) of a magnetic path formed at this facing portion.

An annular recess 33c is formed in an outer peripheral surface of a tip end side end portion of the yoke 33, extending in a circumferential direction. The yoke 33 and the cylindrical body 5 are joined together by laser welding at a thinner portion formed in a bottom part of the annular recess 33c throughout an entire circumference of the annular recess 33c.

A cylindrical protector 49 has a flange portion 49a, and is placed to surround and thereby protect the tip end portion of the cylindrical body 5. The protector 49 covers a laser welding portion 24 of the yoke 33.

An annular groove 34 is formed by the flange portion 49a of the protector 49, the smaller diameter part 33b of the yoke 33, and a step surface between the larger diameter part 33a and the smaller diameter part 33b of the yoke 33. An O-ring 46 is fitted in the annular groove 34. The O-ring 46 functions as a seal that secures liquid tightness and air tightness between an inner peripheral surface of an insertion hole formed at the internal combustion engine side and an outer peripheral surface of the smaller diameter part 33b of the yoke 33 when the fuel injection valve 1 is mounted to the internal combustion engine.

The fuel injection valve 1 is molded by the resin cover 47 that extends from an intermediate portion of the fuel injection valve 1 to a proximity of the base side end portion of the fuel injection valve 1. The resin cover 47 includes a tip end side end portion that covers a part of a base end side of the larger diameter part 33a of the yoke 33. The connector 41 is formed integrally with the resin cover 47, wherein the connector 41 and the resin cover 47 are made of the same resin.

The following describes configuration of the movable element 27 and its proximity in detail with reference to FIG. 2.

FIG. 2 is an enlarged sectional view showing the movable element 27 and its proximity shown in FIG. 1.

In the present embodiment, the movable core 27a and the rod part 27b are formed integrally with each other as one member.

A recess 27aa is formed in a central portion of an upper end surface (upper end part) 27ab of the movable core 27a, extending toward the lower end side. The spring seat 27ag is formed in a bottom of the recess 27aa, to support one end of the coil spring 39. The spring seat 27ag of the recess 27aa further includes an opening 27af that communicates with the inside of the recess 27ba of the rod part 27b.

The opening 27af forms a fuel passage through which the fuel, which has flown from the through hole 25a of the stationary core 25 into a space 27ai of the recess 27aa, flows into a space 27bi of the inside of the rod part 27b.

The upper end surface 27ab of the movable core 27a is an end surface closer to the stationary core 25, and faces the lower end surface 25b of the stationary core 25. The end surface of the movable core 27a opposite to the upper end surface 27ab is an end surface closer to the tip end side (nozzle side) of the fuel injection valve 1, and is henceforth referred to as a lower end surface (lower end portion) 27ak.

The upper end surface 27ab of the movable core 27a and the lower end surface 25b of the stationary core 25 constitute magnetic attraction surfaces on which the magnetic attraction force acts mutually.

In this embodiment, the outer peripheral surface 27ac of the movable core 27a is structured to slide on the inner peripheral surface 5e of the cylindrical member 5. The movable core 27a is guided by the inner peripheral surface 5e to travel in the direction of the valve central axis 27x. The outer peripheral surface 27ac includes a radially projecting portion not shown as a sliding portion in sliding contact with the inner peripheral surface 5e. The inner peripheral surface 5e forms an upstream side guide surface in sliding contact with the outer peripheral surface 27ac of the movable core 27a. The inner peripheral surface 5e and the outer peripheral surface 27ac of the movable core 27a (specifically, the radially projecting portion of the outer peripheral surface 27ac) form an upstream side guide section 50B for guiding travel of the movable element 27.

On the other hand, between the valve element 27c and the valve seat member 15, a downstream guide section 50A is formed as described below. The movable element 27 is arranged to be guided by two points, namely, by the upstream guide section 50B and the downstream guide section 50A, to travel forward and backward in the direction along the central axis 1x (in the valve opening and closing directions).

The rod part 27b includes a communication hole (opening) 27bo that communicates the inside and outside of the portion of the recess 27ba with each other. The communication hole 27bo constitutes a fuel passage that communicates the inside and outside of the portion of the recess 27ba with each other. Accordingly, the fuel, which has flown from the through hole 25a of the stationary core 25 into the recess 27ba, flows through the communication hole 27bo into the fuel chamber 37.

The following describes configuration of the nozzle part 8 in detail with reference to FIG. 3. FIG. 3 is an enlarged sectional view showing a nozzle part 8 and its proximity shown in FIG. 2.

The valve seat member 15 includes through holes 15d, 15c, 15v, and 15e which are formed to extend through the valve seat member 15 in the direction along the central axis 1x. The through holes include a conical surface (through hole 15v) that is formed in an intermediate region of the through holes and has a diameter decreasing toward the downstream side. In strict definition, the through hole 15v has a shape of a side surface of a truncated cone.

The valve seat 15b is formed in the conical surface 15v. The valve element 27c is arranged to be abutted on and separated from the valve seat 15b, and thereby open and close the fuel passage. The conical surface 15v where the valve seat 15b is formed may be referred to as a valve seat surface.

The valve seat 15b may be referred to as seat portion. The portion of the valve element 27c which abuts the valve seat 15b may be referred to also as seat portion. The portion of the valve seat 15b and the portion of the valve element 27c which abuts each other may be referred to also as seat portion. When the term “seat portion” is employed, the seat portion of the valve seat member 15 is referred to as valve seat side seat portion, the seat portion of the valve element 27c is referred to as valve element side seat portion, and the portion of the valve seat 15b and the portion of the valve element 27c which abuts each other is referred to simply as seat portion. The portion of the valve seat 15b and the portion of the valve element 27c which abuts each other constitute a seal portion for sealing of fuel when the valve is closed.

In the through holes 15d, 15c, 15v, and 15e, the conical surface (through holes 15v) and the part on the upper side of the conical surface (i.e. the through holes 15d, 15c, and 15v) constitute a valve element receiving hole for receiving the valve element 27c. A guide surface is formed on the inner peripheral surfaces of the through holes 15d, 15c, and 15v, and is arranged to guide the valve element 27c in the direction along the central axis 1x. The guide surface constitutes the guide surface of the downstream side guide section 50A that is the downstream one of the two guide sections 50A and 50B for guiding the movable element 27. The downstream guide surface and the sliding contact surface (sliding surface) 27cb of the valve element 27c in sliding contact with this downstream side guide surface constitute the downstream side guide section 50A arranged to guide travel of the movable element 27.

The upstream portion of the guide surface is constituted by a diameter-widened portion (through hole 15d) whose inside diameter is larger than an inside diameter of the through hole 15c constituting the guide surface, and increases from the lower side to the upper side.

The lower end of the through holes 15d, 15c, and 15v is connected to the through hole 15e which serves as a fuel introduction hole. The lower end of the through hole 15e is open at the tip end surface 15t of the valve seat member 15.

The nozzle plate 21n is mounted to the tip end surface 15t of the valve seat member 15. The nozzle plate 21n is fixed to the valve seat member 15 by laser welding. A laser welding portion 23 is formed to encircle an injection orifice forming area where fuel injection orifices 110 are provided.

The nozzle plate 21n is constituted by a plate member (flat plate) having a uniform thickness. The nozzle plate 21n includes a protruding portion 21na which is formed at a central portion of the nozzle plate 21n to protrude outwardly. The protruding portion 21na is formed to have a curved surface (for example, spherical surface). A fuel chamber 21a is formed within the protruding portion 21na. This fuel chamber 21a is connected to the through hole 15e that is the fuel introduction hole formed in the valve seat member 15. The fuel is supplied through the through hole 15e to the fuel chamber 21a.

The protruding portion 21na includes the fuel injection orifices 110. Configurations of the fuel injection orifices 110 are not specifically limited. A swirl chamber may be provided on the upstream side of the fuel injection orifices 110 for producing a swirl force to the fuel. Central axes 110a of the fuel injection orifices may be parallel or inclined to the central axis 1x of the fuel injection valve. Moreover, the protruding portion 21na may be omitted.

The nozzle plate 21n constitutes a fuel injection part 21 that determines the form and pattern of the fuel spray. The valve seat 15 and the fuel injection part 21 constitute the nozzle part 8 for injecting the fuel. The valve element 27c may be regarded as a component of the nozzle part 8.

In this embodiment, the valve element 27c is implemented by a ball valve having a spherical shape.

Accordingly, the valve element (ball valve) 27c has a spherical outer surface. The valve element 27c includes a plurality of cutaway surfaces 27ca which are formed at portions facing the through hole 15c, and which are positioned at intervals in the circumferential direction. These cutaway surfaces 27ca constitute the fuel passages arranged to supply the fuel to the seat portion. The valve element 27c may be implemented by a different type of valve element from ball valves.

In the present embodiment, the valve seat member 15 is press-fitted inside of an inner peripheral surface 5f of the tip end portion of the cylindrical body 5, and then fixed to the cylindrical body 5 through a weld portion 19.

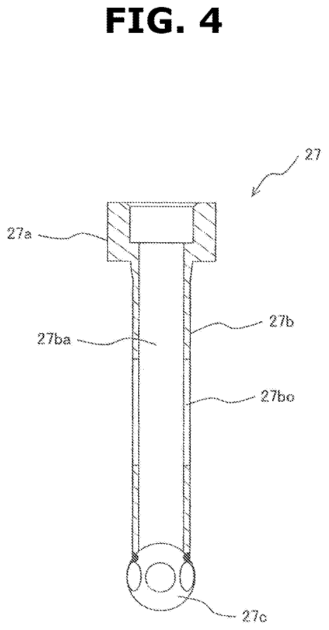

FIG. 4 is a sectional view showing a modified example of the movable element in the fuel injection valve according to the embodiment of the present invention. In the embodiment described above, the rod part 27b of the movable element 27 is implemented by the solid rod member, but may be implemented by a hollow cylindrical member as shown in FIG. 4. In this case, the recess 27ba is replaced by a through hole that extends through the cylindrical rod part 27b in the direction of the central axis 27x. The communication hole 27bo is formed to communicate with the inside and outside of the portion of the recess 27ba.

Also in the case of the movable element 27 shown in FIG. 4, the valve element 27c is joined to the tip end portion (lower end portion) of the rod part 27b by welding. This welding is detailed below. For the welding according to the present invention, it is preferable that the surface of the rod part 27b facing the valve element 27c has a large area. Accordingly, it is more advantageous to implement the rod part 27b by a solid rod part or rod member than by a hollow rod part or member.

The following describes the welding between the rod part (connection part) 27b and the valve element 27c.

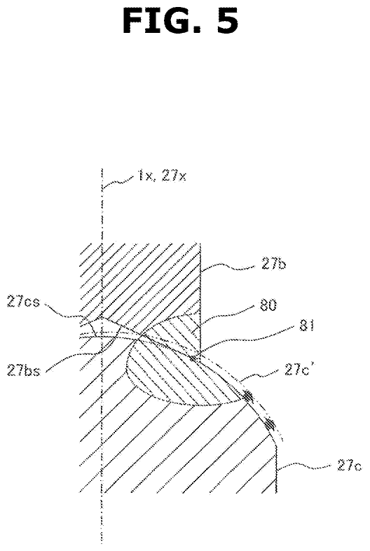

First, the following describes a problem about the welding between the rod part 27b and the valve element 27c. FIG. 5 is a conceptual diagram illustrating a problem about welding between a valve element and a rod part.

FIG. 5 shows a condition that the rod part 27b is made to abut the spherical surface of the valve element 27c, and is then welded thereto. The rod part 27b is structured to have an end surface (facing surface 27bs) facing the valve element 27c, wherein the facing surface 27bs is implemented by a tapered surface (conical surface) whose diameter decreases gradually as followed from its lower side to its upper side. On the other hand, the valve element 27c is made to have a facing surface 27cs facing the rod part 27b, wherein the facing surface 27cs has a spherical shape. The rod part 27b is made to abut the valve element 27c such that an outer periphery (outer edge) 81 of the tapered shape of the facing surface 27bs of the rod part 27b abuts the facing surface 27cs of the valve element 27c.

The welding forms a weld penetration portion in a region indicated by a reference sign 80. The abutment portion 81 between the valve element 27c and the rod part 27b is contained in the weld penetration portion 80. This makes it impossible to maintain the positional relationship between the valve element 27c and the rod part 27b. The weld penetration portion 80 is formed when members are melded by heat input by welding and then cooled and solidified. During the welding, the valve element 27c and the rod part 27b expand due to the heat inputted to the place of welding, and thereafter contract. The thermal expansion and contraction of the valve element 27c and the rod part 27b with the weld penetration portion 80 melded, causes a change in the overall length of the rod part 27b in the direction of valve central axis 27x with unfixed positional relationship between the valve element 27c and the rod part 27b.

This cause a deviation in position between the valve element 27c and the rod part 27b. In FIG. 5, a two dot chain line represents a valve element 27c′ whose position has deviated.

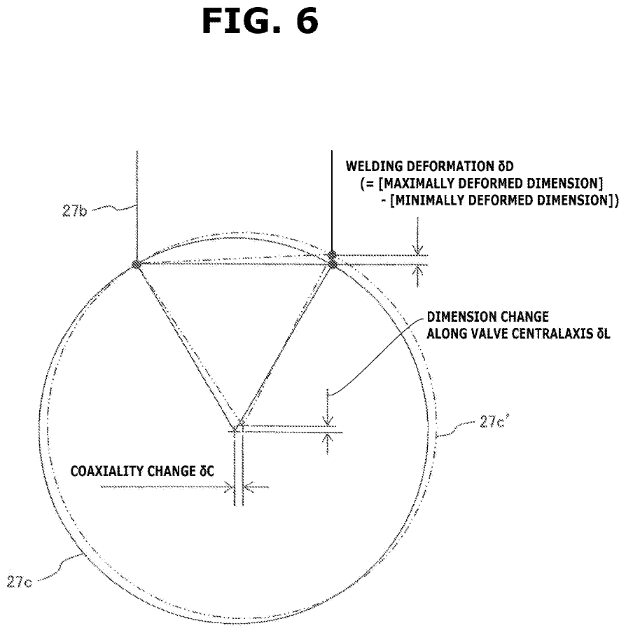

The following describes positional deviation between the valve element 27c and the rod part 27b during welding with reference to FIG. 6. FIG. 6 is a conceptual diagram illustrating a change in positional relationship (positional deviation) between the valve element and the rod part caused by welding therebetween.

Generally, the welding between the valve element 27c and the rod part 27b is implemented by employing a laser beam or electron beam. This art of welding is implemented by moving a spot of irradiation of the beam circumferentially of the rod part 27b, and thereby forming the weld penetration portion 80 over the entire circumference of the rod part 27b. While the spot of irradiation of the beam is being moved circumferentially of the rod part 27b, the temperature of the rod part 27b changes. This causes a variation in the quantity of change of dimension of the rod part 27b in the direction of the central axis 27x due to expansion and contraction, in the circumferential direction of the rod part 27b.

FIG. 6 shows conceptually a situation that the change of the longitudinal dimension of the rod part 27b varies in the circumferential direction of the rod part 27b, and the difference between the dimension change of the rod part 27b at a position of maximum deformation and the dimension change of the rod part 27b at a position of minimum deformation causes a welding deformation quantity δD that is a quantity of deformation of the rod part 27b due to the welding.

The welding deformation quantity δD shown in FIG. 6 causes a coaxiality change quantity δC that is a deviation of the center of the valve element 27c from the central axis of the rod part 27b. The welding deformation quantity δD also causes a dimension change quantity δL that is a deviation of the center of the deviated valve element 27c′ from the center of the unwelded valve element 27c. The dimension change quantity δL in the direction of the valve central axis 27x is a quantity of change of the entire length of the movable element 27.

As described above, the welding deformation quantity δD causes a change in the overall length of the movable element 27, and also adversely affects the coaxiality between the valve element 27c and the rod part 27b.

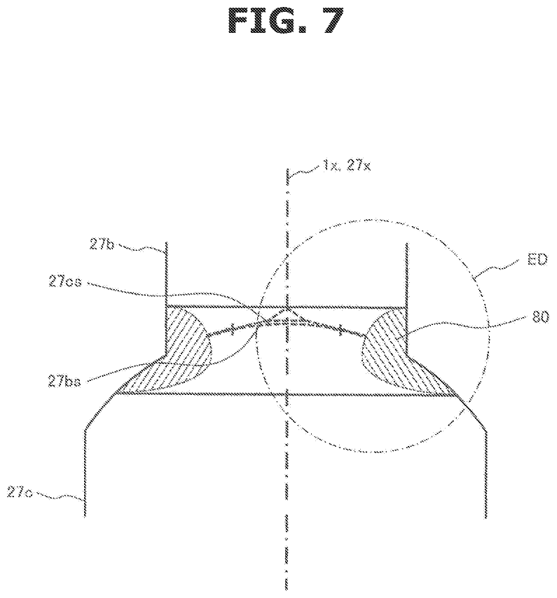

FIG. 7 is a schematic diagram showing an internal structure of a portion of welding between the valve element and the rod part by broken lines.

FIG. 7 shows the exterior of the weld portion between the valve element 27c and the rod part 27b in the sectional view taken along the plane containing the central axis 27x, in which broken lines represent the weld penetration portion 80, the facing surface 27bs of the rod part 27b facing the valve element 27c, and the facing surface 27cs of the valve element 27c facing the rod part 27b. The portions represented by the broken lines correspond to a configuration according to the first embodiment described below. As shown in FIG. 7, the weld penetration portion 80 extends over both of the valve element 27c and the rod part 27b.

The following describes examples of the weld portion between the valve element 27c and the rod part 27b according to the first, second, and third embodiments individually. The configuration described above is common among the first, second, and third embodiments.

### First Embodiment

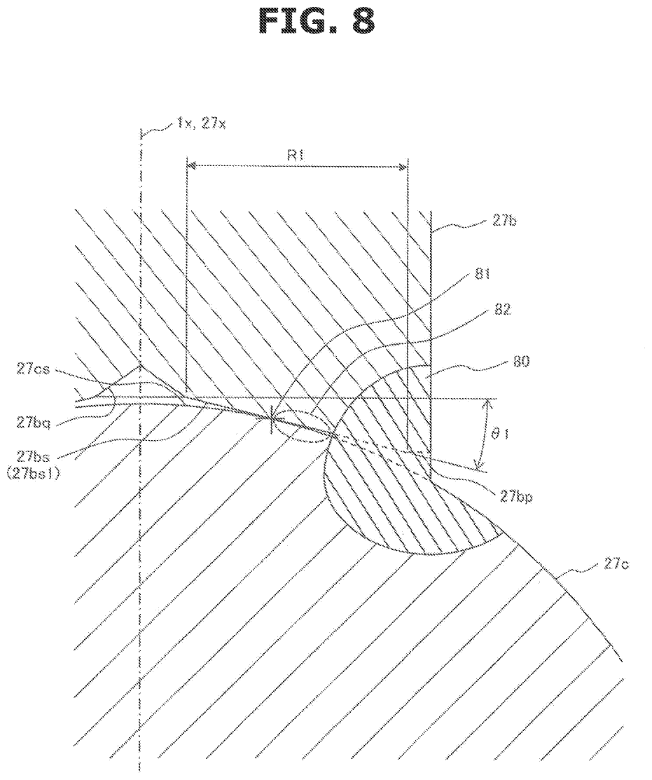

The following describes the weld portion between the valve element 27c and the rod part 27b according to the first embodiment with reference to FIG. 8. FIG. 8 is a sectional view of the portion of welding between the valve element and the rod part according to the first embodiment, taken along a plane containing the valve central axis. FIG. 8 is an enlarged sectional view showing a section of a portion indicated by “ED” in FIG. 7.

In the present embodiment, the facing surface 27bs of the rod part 27b, which is an end surface of the rod part 27b facing the valve element 27c, is constituted by a facing surface part (first facing surface part) 27bs1 having a taped shape whose diameter decreases gradually from the lower side to the upper side. The first facing surface part 27bs1 is defined by a straight line in the sectional view taken along the plane containing the valve central axis 27x, and includes a conical surface that is inclined from the central axis 27x in the sectional view.

On the other hand, the facing surface 27cs of the valve element 27c facing the rod part 27b has a spherical shape. The rod part 27b includes an abutment portion (contact portion) 81 between the inner periphery and the outer periphery of the first facing surface part 27bs1 and apart from the inner periphery and the outer periphery of the first facing surface part 27bs1, wherein the rod part 27b abuts the facing surface 27cs of the valve element 27c at the abutment portion 81. In this example, the abutment portion 81 is formed annularly. Specifically, the rod part 27b is made to abut the valve element 27c by the annular abutment portion 81 of the rod part 27b made to abut the facing surface 27cs of the valve element 27c.

In the sectional view of FIG. 8, the first facing surface part 27bs1 has an inclination angle θ1 with respect to a level plane perpendicular to the valve central axis 27x such that its outer peripheral side is located lower than its inner peripheral side. In the present embodiment, the first facing surface part 27bs1 is formed in the facing surface 27bs as one tapered surface. The first facing surface part 27bs1 is formed in a region R1 between a clearance part (recess) 27bq and a level part 27bp, wherein the clearance part 27bq is formed for machining at a central portion of the facing surface 27bs, and wherein the level part 27bp has an annular shape and is formed at the outer periphery of the facing surface 27bs.

The welding between the valve element 27c and the rod part 27b forms the weld penetration portion 80 extending over the valve element 27c and the rod part 27b. In FIG. 8, broken lines represent the shape of the valve element 27c and the shape of the rod part 27b before the weld penetration portion 80 is formed.

Before the welding is performed, the rod part 27b is made to abut the valve element 27c at the abutment portion 81, with a clearance between the facing surface 27cs of the valve element 27c and the facing surface 27bs of rod part 27b radially outside of the abutment portion 81, so that the valve element 27c is out of contact with the rod part 27b radially outside of the abutment portion 81.

After the welding is performed, a part of the facing surface 27cs of the valve element 27c and a part of the facing surface 27bs of the rod part 27b are melted by heat input due to the welding, thereby forming the weld penetration portion 80. The abutment portion 81 is located out of the weld penetration portion 80. Namely, the abutment portion 81 is located closer to the central axis 27x in the radial direction than the weld penetration portion 80, wherein an unwelded portion is provided between the abutment portion 81 and the weld penetration portion 80 where no melting is caused by the welding. In the unwelded portion, the facing surface 27cs of the valve element 27c and the facing surface 27bs of the rod part 27b are maintained unmelted.

The contact at the abutment portion 81 between the first facing surface part 27bs1 tapered and the spherical shape is a line contact ideally. This ensures a clearance between the valve element 27c and the rod part 27b also radially inside of the abutment portion 81. Actually, it is difficult to achieve a line contact, due to limitation of machining. However, the contact at the abutment portion 81 is nearly a line contact.

Furthermore, in the present embodiment, a clearance part (clearance-forming part) 82 is provided between the abutment portion 81 and the weld penetration portion 80 in the radial direction of the facing surface 27bs. In the clearance part 82, the facing surface 27bs of the rod part 27b is out of contact with the facing surface 27cs of the valve element 27c, wherein there is a clearance between the facing surface 27bs and the facing surface 27cs. The clearance part (clearance-forming part) 82 serves as a separation part to separate the abutment portion 81 from the weld penetration portion 80, and form an unwelded portion between the abutment portion 81 and the weld penetration portion 80.

In the present embodiment, the feature that the abutment portion 81 is located radially inside of the weld penetration portion 80, serves to prevent the abutment portion 81 from being melted by heat input due to welding, and thereby maintain the abutment portion 81 solid. This serves to maintain the positional relationship between the valve element 27c and the rod part 27b also during the welding, and thereby prevent or suppress the valve element 27c from deviating in position from the rod part 27b.

In particular, the feature that the clearance part 82 is provided between the abutment portion 81 and the weld penetration portion 80 to separate the abutment portion 81 from the weld penetration portion 80, serves to reliably prevent weld penetration at the abutment portion 81.

The present embodiment serves to prevent weld penetration of the abutment portion 81 during welding, and thereby maintain the positional relationship between the valve element 27c and the rod part 27b. This prevents or suppresses the overall length of the movable element 27 from being change, and prevents or suppresses the coaxiality between the valve element 27c and the rod part 27b from being adversely affected. This enhances the dimension accuracy and weld quality of the movable element 27.

### Second Embodiment

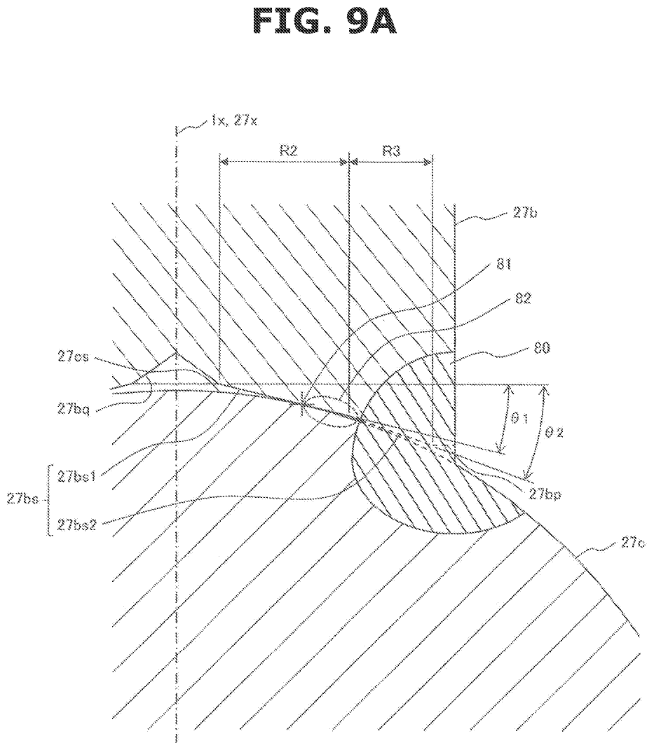

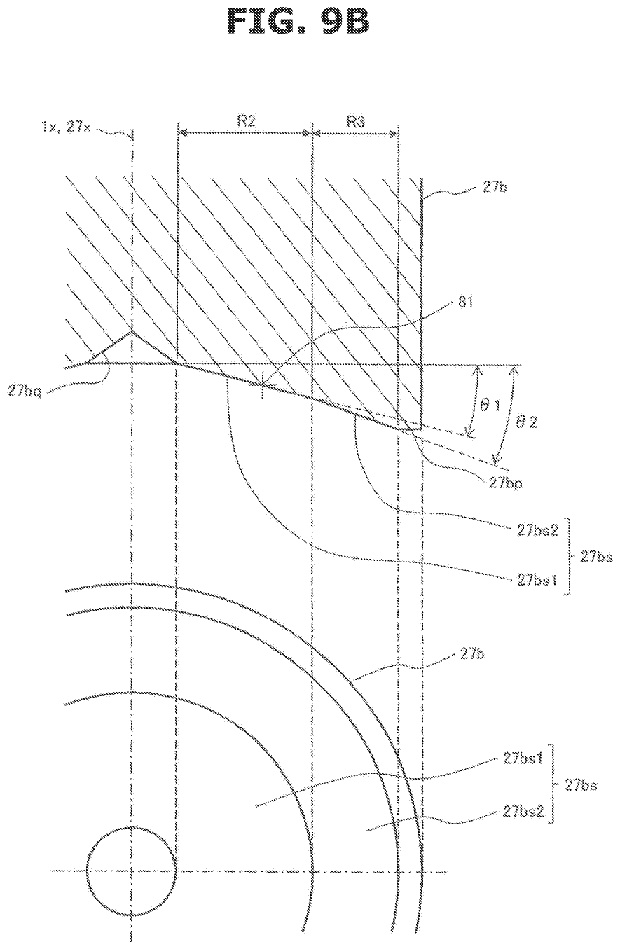

The following describes the example of welding between the valve element 27c and the rod part 27b according to the first embodiment with reference to FIGS. 9A and 9B. FIG. 9A is a sectional view of the portion of welding between the valve element and the rod part according to the second embodiment, taken along a plane containing the valve central axis. FIG. 9B is a sectional view (on the upper side) and a plan view (on the lower side) showing the portion of welding between the valve element and the rod part according to the second embodiment.

FIGS. 9A and 9B are enlarged views showing a section of the portion indicated by “ED” in FIG. 7.

In the present embodiment, the end surface (facing surface) 27bs of the rod part 27b facing the valve element 27c is composed of the first facing surface part 27bs1 and a second facing surface part 27bs2 having a tapered shape. Similar to the first facing surface part 27bs1, the second facing surface part 27bs2 has a conical shape whose diameter decreases gradually from the lower side to the upper side, and is defined by a straight line in the sectional view taken along the plane containing the valve central axis 27x.

In the present embodiment, the second facing surface part 27bs2 is provided radially outside of the first facing surface part 27bs1, wherein the region R1 where the first facing surface part 27bs1 according to the first embodiment is formed is separated into an inner region R2 and an outer region R3, and wherein the first facing surface part 27bs1 is formed in the region R2 and the second facing surface part 27bs2 is formed in the region R3.

Also in the present embodiment, the abutment portion 81 between the valve element 27c and the rod part 27b is located at the first facing surface part 27bs1, and is out of contact with the weld penetration portion 80 where melding occurs due to heat input by welding. Furthermore, the clearance part 82 is provided between the abutment portion 81 and the weld penetration portion 80 in the radial direction of facing surface 27bs.

The second facing surface part 27bs2 has an inclination angle θ2 that is larger than the inclination angle θ1 of first facing surface part 27bs1. This serves to allow the outer periphery of the facing surface 27bs of the rod part 27b to be close to the facing surface 27cs of the valve element 27c facing the rod part 27b, while the second facing surface part 27bs2 exists radially outside of the first facing surface part 27bs1, as compared to cases where only the first facing surface part 27bs1 is formed in the regions R2 and R3. Namely, this serves to set the clearance between the facing surface 27bs and the facing surface 27cs smaller than when the second facing surface part 27bs2 is replaced with the first facing surface part 27bs1.

In the present embodiment, the feature that the clearance between the facing surface 27bs and the facing surface 27cs at the outer periphery of the facing surface 27bs is set small, serves to set small the clearance between the facing surface 27bs and the facing surface 27cs at the weld penetration portion 80. This serves to suppress the occurrence of sputtering during the welding.

Except for the configuration described above, the second embodiment is configured and produces advantageous effects, similar to the first embodiment.

### Third Embodiment

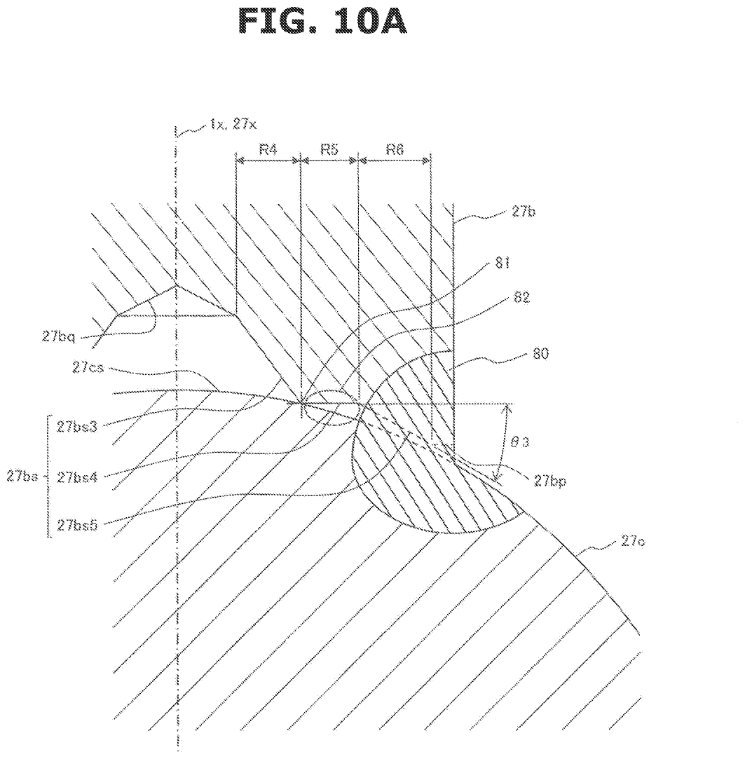

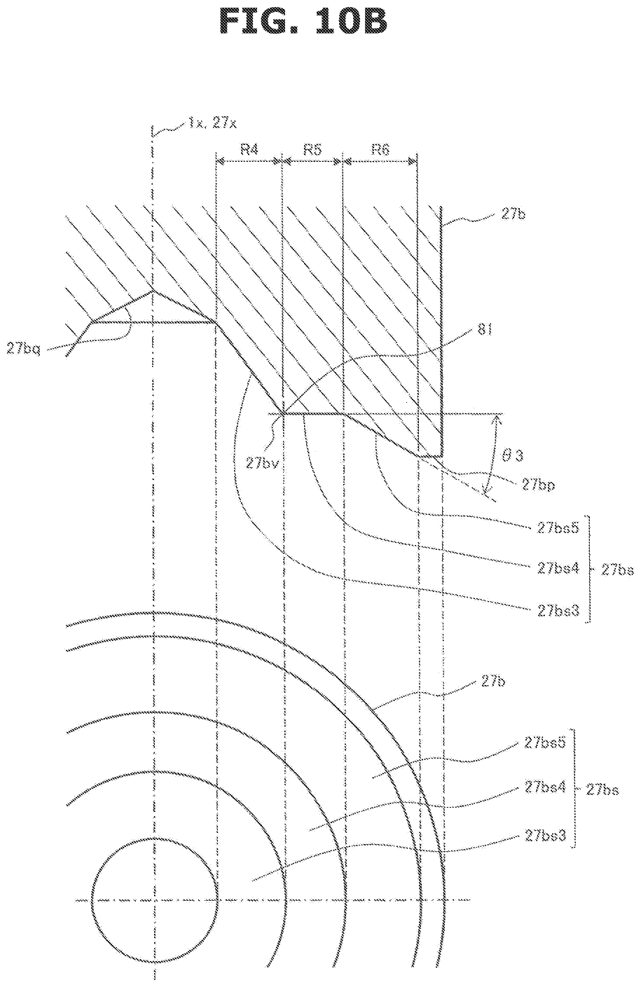

The following describes the example of welding between the valve element 27c and the rod part 27b according to the first embodiment with reference to FIGS. 10A and 10B. FIG. 10A is a sectional view of the portion of welding between the valve element and the rod part according to the third embodiment, taken along a plane containing the valve central axis. FIG. 10B is a sectional view (on the upper side) and a plan view (on the lower side) showing the portion of welding between the valve element and the rod part according to the third embodiment. FIGS. 10A and 10B are enlarged views showing a section of the portion indicated by “ED” in FIG. 7. Components common among the first embodiment, the second embodiment, and the third embodiment are given the same reference signs without repeated description. The components that are given the same reference signs but different from the first embodiment and the second embodiment are described as appropriate. In FIG. 10A, broken lines represent the shape of valve element 27c and the shape of rod part 27b before formation of the weld penetration portion 80.

In the present embodiment, the end surface (facing surface) 27bs of the rod part 27b facing the valve element 27c includes a first facing surface part 27bs4 at a central position in the radial direction, and a second facing surface part 27bs5 radially outside of the first facing surface part 27bs4, and a third facing surface part 27bs3 radially inside of the first facing surface part 27bs4.

The first facing surface part 27bs4 has an annular level surface. Each of the second facing surface part 27bs5 and the third facing surface part 27bs3 has a tapered surface (conical surface) whose diameter decreases gradually from the lower side to the upper side.

The first facing surface part 27bs4 is defined by a straight line in the sectional view taken along the plane containing the central axis 27x, and may be alternatively implemented by a tapered surface (conical surface). Also, each of the second facing surface part 27bs5 and the third facing surface part 27bs3 is defined by a straight line in the sectional view taken along the plane containing the central axis 27x. If the first facing surface part 27bs4 is implemented by a tapered surface, the relationship in inclination angle with respect to the level plane between the first facing surface part 27bs4 and the second facing surface part 27bs5 is set the same as that between the first facing surface part 27bs1 and the second facing surface part 27bs2 according to the second embodiment. Namely, the inclination angle of the first facing surface part 27bs4 with respect to the level plane is set smaller than that of the second facing surface part 27bs5. Furthermore, the inclination angle of the first facing surface part 27bs4 with respect to the level plane is set smaller than that of the third facing surface part 27bs3.

In the present embodiment, the region R1 according to the first embodiment is separated into an innermost region R4, an outermost region R6, and an intermediate region R5, wherein the tapered surface (third facing surface part) 27bs3 is formed in the region R4, and the annular level plane part (first facing surface part) 27bs4 is formed in the intermediate region R5, and the tapered surface (second facing surface part) 27bs5 is formed in the region R6. The intermediate region R5 is interposed between the region R4 and the region R6 for connection therebetween.

In the present embodiment, the third facing surface part 27bs3 and the first facing surface part 27bs4 are important.

The portion of connection between the third facing surface part 27bs3 and the first facing surface part 27bs4 forms an edge part 27bv having an annular shape. At the abutment portion 81, the annular edge part 27bv is in line contact with the spherical shape of the valve element 27c. Namely, in the present embodiment, the abutment portion 81 is formed at the inner periphery of the first facing surface part 27bs4. In another viewpoint, the abutment portion 81 is formed at the outer periphery of the third facing surface part 27bs3. It is difficult to achieve a line contact of the abutment portion 81, due to limitation of machining. However, the contact at the abutment portion 81 is nearly a line contact.

In the present embodiment, the provision of the edge part 27bv for the abutment portion 81 serves to set the width of contact between the valve element 27c and the rod part 27b smaller than in the first embodiment and the second embodiment.

In the present embodiment, each of the inside and outside of the abutment portion 81 in the radial direction is provided with a clearance between the valve element 27c and the rod part 27b. The second facing surface part 27bs5 serves similar to the second facing surface part 27bs2 of the second embodiment, and serves to set small the clearance between the facing surface 27bs of the rod part 27b and the facing surface 27cs of the valve element 27c, and thereby suppress the occurrence of sputtering during the welding.

Except for the configuration described above, the second embodiment is configured and produces advantageous effects, similar to the first embodiment.

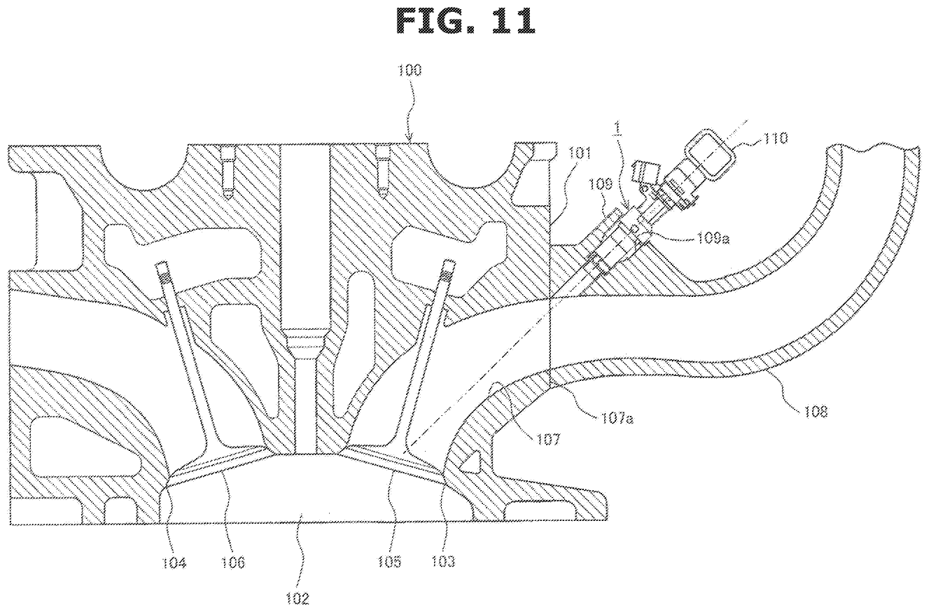

The following describes the internal combustion engine to which the fuel injection valve according to the present invention is mounted, with reference to FIG. 11. FIG. 11 is a sectional view of the internal combustion engine to which the fuel injection valve is mounted.

The internal combustion engine 100 includes an engine block 101, and a cylinder 102 formed in the engine block 101. An intake port 103 and an exhaust port 104 are provided at an apex portion of the cylinder 102. The intake port 103 is provided with an intake valve 105 that is arranged to open and close the intake port 103. The exhaust port 104 is provided with an exhaust valve 106 that is arranged to open and close the exhaust port 104. The engine block 101 includes an intake flow passage 107 connected to the intake port 103. The intake flow passage 107 includes an inlet side end portion 107a connected to an intake pipe 108.

The fuel supply opening 2 (see FIG. 1) of the fuel injection valve 1 is connected to the fuel pipe.

The intake pipe 108 includes a mounting part 109 for the fuel injection valve 1. The mounting part 109 includes an insertion opening 109a into which the fuel injection valve 1 is inserted. The insertion opening 109a extends to an inner wall surface (intake flow passage) of the intake pipe 108. The fuel injected from the fuel injection valve 1 inserted into the insertion opening 109a is injected into the intake flow passage. In case of two directional spraying, in the internal combustion engine in which the engine block 101 is provided with two intake openings 103, two fuel sprays are directed and injected to the respective intake openings 103 (intake valves 105).

In the embodiments described above, if the first facing surface part 27bs1, 27bs4, and the edge part 27bv, and the abutment portion 81 are formed annularly, the annular shape is not limited to a continuous annular shape, but may be parts of an annular shape separated in the circumferential direction.

In the embodiments described above, the feature that the abutment portion 81 is formed somewhere in the first facing surface part 27bs1, 27bs4 in the radial direction, ensures that the rod part 27b abuts the valve element 27c at the abutment portion 81.

In the embodiments described above, the rod part 27b is welded to the valve element 27c under the condition that the abutment portion 81 between the rod part 27b and the valve element 27c is provided radially inside of the weld penetration portion 80 to be produced by the welding. When the weld penetration portion 80 is melted by heat input by the welding, the abutment portion 81 serves to maintain the positional relationship between the rod part 27b and the valve element 27c, and thereby prevent or suppress the valve element 27c from deviating in position from the rod part 27b.

The present invention is not limited to the embodiments described above. Part of the features may be omitted, and other features not described above may be added. The features of each embodiment described above may be combined with those of other embodiments, unless the combination causes a technical conflict.

The fuel injection valve according to the embodiments described above may be exemplified as follows.

According to one aspect, a fuel injection valve includes a movable element, wherein: the movable element includes: a movable core; a valve element; and a rod part connected between the movable core and the valve element and including a first end welded to the valve element; the rod part and the valve element include an abutment portion at which the rod part abuts the valve element; the rod part and the valve element include a weld penetration portion produced by welding of the rod part and the valve element; the abutment portion is closer to a valve central axis than the weld penetration portion; and the rod part and the valve element include an unwelded portion between the abutment portion and the weld penetration portion.

According to a preferable aspect, the fuel injection valve is configured such that: the unwelded portion includes a clearance between a rod part side facing surface and a valve element side facing surface; the rod part side facing surface is a surface of the rod part facing the valve element; and the valve element side facing surface is a surface of the valve element facing the rod part.

According to another preferable aspect, the fuel injection valve according to one of the foregoing aspects is configured such that: the valve element side facing surface has a spherical shape; the rod part side facing surface includes a first facing surface part; the first facing surface part is defined by a straight line in a sectional view taken along a plane containing the valve central axis; and the first facing surface part abuts the spherical shape at the abutment portion.

According to another preferable aspect, the fuel injection valve according to one of the foregoing aspects is configured such that: the rod part side facing surface includes the first facing surface part and a second facing surface part; the first facing surface part has a tapered shape such that an inner periphery of the first facing surface part is closer to a base end of the fuel injection valve than an outer periphery of the first facing surface part; the second facing surface part is located radially outside of the first facing surface part and has a tapered shape such that an inner periphery of the second facing surface part is closer to the base end of the fuel injection valve than an outer periphery of the second facing surface part; and the second facing surface part has a larger inclination angle with respect to a level plane perpendicular to the valve central axis than the first facing surface part.

According to another preferable aspect, the fuel injection valve according to one of the foregoing aspects is configured such that: the rod part side facing surface includes: a third facing surface part located radially inside of the first facing surface part and has a tapered shape such that an inner periphery of the third facing surface part is closer to the base end of the fuel injection valve than an outer periphery of the third facing surface part; and an edge part formed annularly at a place of connection between the inner periphery of the first facing surface part and the outer periphery of the third facing surface part; and the edge part abuts the spherical shape at the abutment portion.

According to another preferable aspect, the fuel injection valve according to one of the foregoing aspects is configured such that: the rod part side facing surface includes an edge part formed annularly at an inner periphery of the first facing surface part; and the edge part abuts the spherical shape at the abutment portion.

The production process for fuel injection valve according to the embodiments described above may be exemplified as follows.

According to one aspect, a production process for a fuel injection valve including a movable element, wherein: the movable element includes: a movable core; a valve element; and a rod part connected between the movable core and the valve element and including a first end welded to the valve element; and the production process includes welding the valve element to the first end of the rod part by: causing a rod part side facing surface to abut a valve element side facing surface at a radially intermediate place, wherein the rod part side facing surface is a surface of the rod part facing the valve element, and the valve element side facing surface is a surface of the valve element facing the rod part; and producing a weld penetration portion radially outside of an abutment portion at which the rod part side facing surface abuts the valve element side facing surface, for welding of the rod part and the valve element, while providing an unwelded portion between the abutment portion and the weld penetration portion.

1. A fuel injection valve comprising a movable element, wherein:
the movable element includes:
a movable core;
a valve element; and
a rod part connected between the movable core and the valve element and including a first end welded to the valve element;
the rod part and the valve element include an abutment portion at which the rod part abuts the valve element;
the rod part and the valve element include a weld penetration portion produced by welding of the rod part and the valve element;
the abutment portion is closer to a valve central axis than the weld penetration portion; and
the rod part and the valve element include an unwelded portion between the abutment portion and the weld penetration portion.

2. The fuel injection valve as claimed in claim 1, wherein:
the unwelded portion includes a clearance between a rod part side facing surface and a valve element side facing surface;
the rod part side facing surface is a surface of the rod part facing the valve element; and
the valve element side facing surface is a surface of the valve element facing the rod part.

3. The fuel injection valve as claimed in claim 2, wherein:
the valve element side facing surface has a spherical shape;
the rod part side facing surface includes a first facing surface part;
the first facing surface part is defined by a straight line in a sectional view taken along a plane containing the valve central axis; and
the first facing surface part abuts the spherical shape at the abutment portion.

4. The fuel injection valve as claimed in claim 3, wherein:
the rod part side facing surface includes the first facing surface part and a second facing surface part;
the first facing surface part has a tapered shape such that an inner periphery of the first facing surface part is closer to a base end of the fuel injection valve than an outer periphery of the first facing surface part;
the second facing surface part is located radially outside of the first facing surface part and has a tapered shape such that an inner periphery of the second facing surface part is closer to the base end of the fuel injection valve than an outer periphery of the second facing surface part; and
the second facing surface part has a larger inclination angle with respect to a level plane perpendicular to the valve central axis than the first facing surface part.

5. The fuel injection valve as claimed in claim 4, wherein:
the rod part side facing surface includes:
a third facing surface part located radially inside of the first facing surface part and has a tapered shape such that an inner periphery of the third facing surface part is closer to the base end of the fuel injection valve than an outer periphery of the third facing surface part; and
an edge part formed annularly at a place of connection between the inner periphery of the first facing surface part and the outer periphery of the third facing surface part; and
the edge part abuts the spherical shape at the abutment portion.

6. The fuel injection valve as claimed in claim 3, wherein:
the rod part side facing surface includes an edge part formed annularly at an inner periphery of the first facing surface part; and
the edge part abuts the spherical shape at the abutment portion.

7. A production process for a fuel injection valve including a movable element, wherein:
the movable element includes:
a movable core;
a valve element; and
a rod part connected between the movable core and the valve element and including a first end welded to the valve element; and
the production process comprises welding the valve element to the first end of the rod part by:
causing a rod part side facing surface to abut a valve element side facing surface at a radially intermediate place, wherein the rod part side facing surface is a surface of the rod part facing the valve element, and the valve element side facing surface is a surface of the valve element facing the rod part; and
producing a weld penetration portion radially outside of an abutment portion at which the rod part side facing surface abuts the valve element side facing surface, for welding of the rod part and the valve element, while providing an unwelded portion between the abutment portion and the weld penetration portion.
